(19) United States
(12) Patent Application Publication
(10) Pub. No.: US 2010/0252548 A1
(43) Pub. Date: Oct. 7, 2010

(54) HOLDING DEVICE FOR INNER POT BODY OF ROAST OVEN

(76) Inventor: Kuei-Tang CHANG, Banchiau City (TW)

Correspondence Address: HDLS Patent & Trademark Services, P.O. BOX 220746, CHANTILLY, VA, 20153-0746, US

(21) Appl. No.: 12/419,381

(22) Filed: Apr. 7, 2009

(51) Int. Cl. A47J 37/04; A21B 1/00

(52) U.S. Cl. 219/392

(57) ABSTRACT

A holding device for inner pot body of roast oven includes an outer pot body and a thermally protective structure. The outer pot body has an accommodative space and at least one opening communicated with the accommodative space. The inner pot body is fixed in the accommodative space. The thermally protective structure is arranged to the outer pot body and is joined therewith corresponding to the opening. The thermally protective structure is made of a thermally insulating materials and is arranged corresponding to the opening. The thermally protective structure and the outer pot body are co-enclosed around the outside of the inner pot body, thereby, enhancing the safety in terms of use.

### BACKGROUND OF THE INVENTION

1. Field of the Invention

The present invention in general relates to a roast oven, in particular, to a holding device for inner pot body of roast oven.

2. Description of Prior Art

For the roast ovens as seen in current market, since their safety laws regulated by each county are incomplete, the pot stand designed for holding the pot body is simpler as well. Even, there is no law regulated for the exposure of the surface of the pot body, on which a high temperature exists. Due to the high temperature on the surface of the roast oven, a user may be scaled by touching it because of careless. Such a worry concerning safety thereby becomes a barrier for selling this kind of roast pot in the market.

As shown in FIG. 1, the pot stand 1a of roast oven according to prior arts is provided for holding a pot body 6a. The pot stand 1a mainly includes two bottom rods 10a, two lateral rods 20a respectively extended upwardly from two sides of each bottom rod 10a and an arc handler 30a that connects the end sides of the two lateral rods 20a and is arranged by crossing the two bottom rods 10a. There is a hollow portion 40a formed between the bottom rod 10a and the two lateral rods 20a or between the arc handler 30a and the two lateral rods 20a. In the meantime, an accommodative space 50a is formed between the two bottom rods 10a and the lateral rods 20a. The pot body 6a is accommodated in the accommodative space 50a by being placed on the two bottom rods 10a. In this case, the pot body 6a is made of a material of tempered glass and contains an accommodative cavity 61a.

When using the pod stand 1a of this roast oven, the food to be roasted is first placed in the accommodative cavity 61a of the pot body 6a. Through the heating and the forced convective flow generated from a fan and a heating element (not shown), the food is thereby undergone a roasting process. In the meantime, through the hollow portions 40a, a user may see through the interior of the pot boy and observe how the food is being roasted therein.

However, for the pot stand 1a of roast oven as described thereinbefore, there are still several drawbacks existed during the practically using procedure. For example, during the heating process of food, since the surface of the pot body 6a has an extremely high temperature, if the user touches the glass-made pot body 6a, which is in high temperature and is exposed to the outside of the pot stand 1a, because of his or her curiosity or carelessness during the using procedure, then he or she will be scalded, so a safety problem does exist in this kind of device. Furthermore, if there is an inflammable article that is located in the neighborhood and carelessly contacts the glass-made pot body 6a, which is in high temperature, then a fire accident is easily occurred.

Therefore, how to improve and solve the aforementioned problems is an issue intended to be addressed by the inventor.

Accordingly, after a substantially devoted study, in cooperation with the application of relatively academic principles, the inventor has finally proposed the present invention that is designed reasonably to possess the capability to improve the drawback of the prior art significantly.

### SUMMARY OF THE INVENTION

The invention is mainly to provide a placing device for inner pot body of roast oven, thereby, addressing the safety issue in terms of use.

Secondly, the invention is to provide a holding device for inner pot body of roast oven, including an outer pot body and a thermally protective structure. The outer pot body has an accommodative space and at least one opening communicated with the accommodative space. The inner pot body is fixed in the accommodative space. The thermally protective structure is arranged to the outer pot body and is joined therewith corresponding to the opening. The thermally protective structure is made of a thermally insulating material and is arranged corresponding to the opening. The thermally protective structure and the outer pot body are co-enclosed around the outside of the inner pot body.

Thirdly, the invention is also to provide a holding device for inner pot body of roast oven, including an outer pot body and a thermally protective structure. The outer pot body has a bottom plate and an enclosing plate extended upwardly from the bottom plate. An accommodative space is formed between the bottom plate and the enclosing plate and at least one opening is arranged on the enclosing plate, while the inner pot body is fixed in the accommodative space. The thermally protective structure is made of a thermally insulating material and is arranged corresponding to the opening. The thermally protective structure and the outer pot body are co-enclosed around the outside of the inner pot body.

Fourthly, the invention is to provide a holding device for inner pot body of roast oven, including an outer pot body and a thermally protective structure. The outer pot body has a bottom plate, two lateral-enclosing plates extended upwardly from the bottom plate and a front-enclosing plate. An accommodative space is formed among the bottom plate, the two lateral-enclosing plates and the front-enclosing plate. At least one opening is provided on the front-enclosing plate. The inner pot body is fixed in the accommodative space. The thermally protective structure is made of a thermally insulating material and is arranged corresponding to the opening. The thermally protective structure and the outer pot body are co-enclosed around the outside of the inner pot body.

Compared to the prior arts, the invention has the following advantageous functions. Firstly, since a thermally protective structure is arranged on the outer pot body, the invention may enhance the safety in terms of use. Secondly, according to the prior arts, because of his or her curiosity or careless, a user may contact the glass-made pot body, which is exposed to the outside of the pot stand and has an extremely high temperature on its surface, such that the user may be scaled. By contrast, the invention is more safe than the prior art in terms of this aspect.

### BRIEF DESCRIPTION OF DRAWING

The features of the invention believed to be novel are set forth with particularity in the appended claims. The invention itself, however, may be best understood by reference to the following detailed description of the invention, which describes several exemplary embodiments of the invention, taken in conjunction with the accompanying drawings, in which:

FIG. 1 is a perspective view of a pot stand of roast oven according to the prior arts;

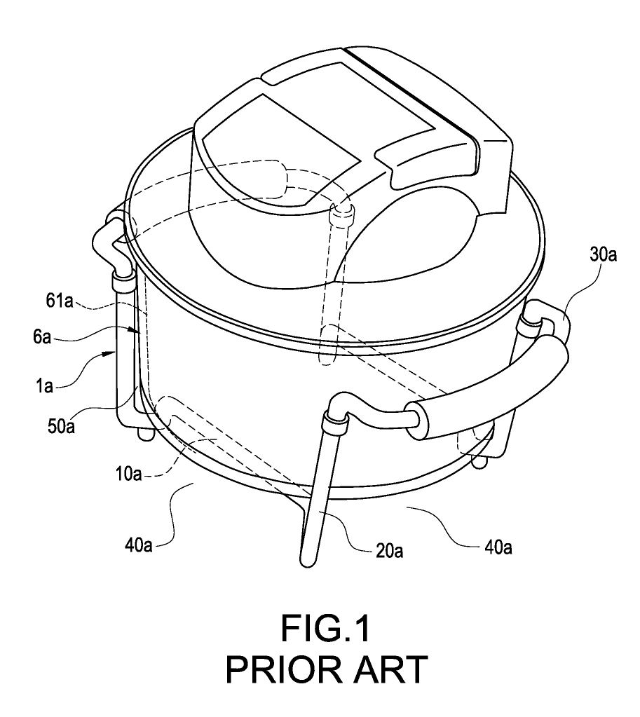

FIG. 2 is a first embodiment according to the present invention;

FIG. 3 is a perspective assembled view of FIG. 2;

FIG. 4 is an illustration of FIG. 3, an inner pot body and a pot lid;

FIG. 5 is a completely assembled view of FIG. 4;

FIG. 6 is a second embodiment according to the present invention;

FIG. 7 is a third embodiment according to the present invention;

FIG. 8 is a fourth embodiment according to the present invention;

FIG. 9 is a fifth embodiment according to the present invention;

FIG. 10 is a sixth embodiment according to the present invention;

FIG. 11 is a seventh embodiment according to the present invention; and

FIG. 12 is an eighth embodiment according to the present invention.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

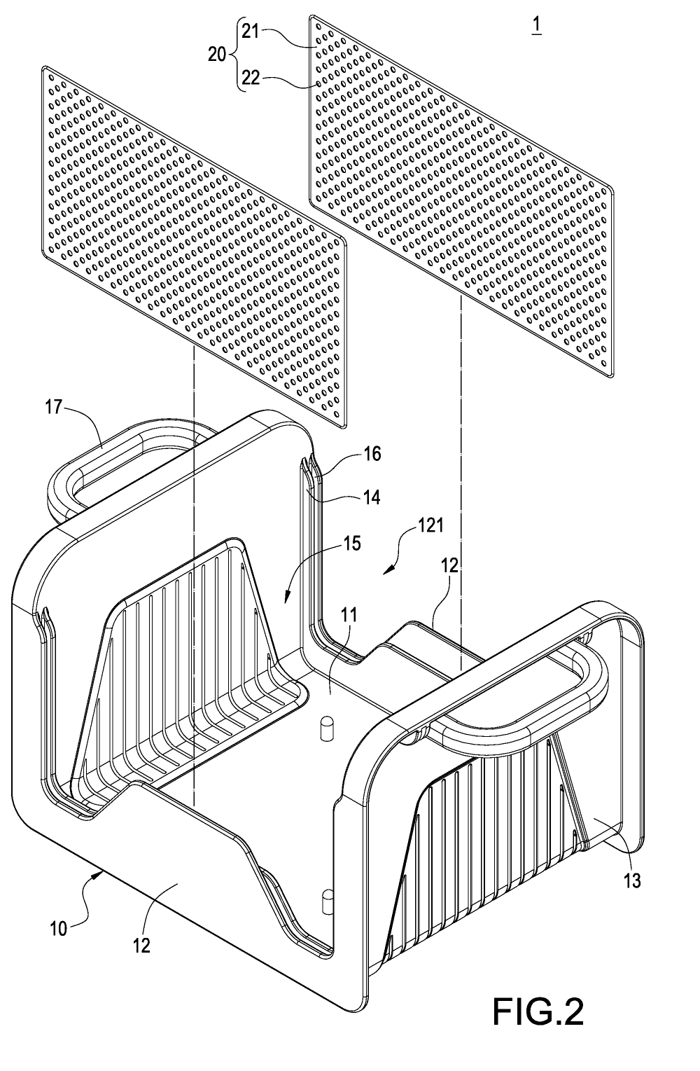

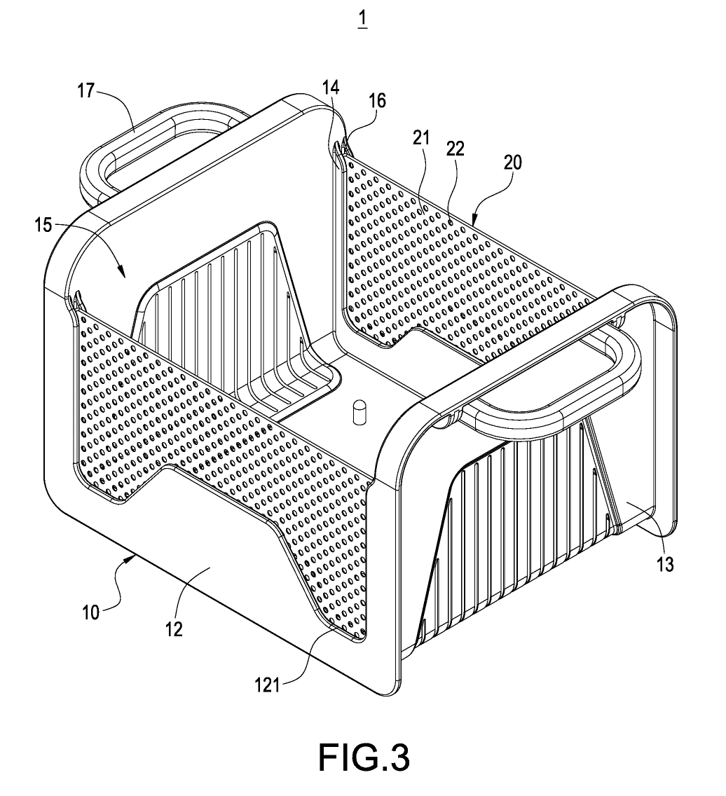

Please refer to FIG. 2 and FIG. 3. The invention is to provide a holding device 1 for inner pot body of roast oven, comprising an outer pot body 10 and a thermally protective structure 20.

The outer pot body 10 has a bottom plate 11, front, rear enclosing plates 12 and two lateral enclosing plates 13 separately extended upwardly from the bottom plate 11 and a side stripe 14 projected from the lateral enclosing plate 13. In addition, an accommodative space 15 is formed by enclosing the bottom plate 11, the lateral enclosing plates 13 and the front, rear enclosing plates 12. Meanwhile, an opening 121 is respectively provided on the front, rear enclosing plates 12. The openings 121 are respectively communicated with the accommodated space 15. A fixing trough 16 is formed between the side stripe 14 and the front enclosing plate 12 or the rear enclosing plate 12. In addition, a handler 17 is respectively projected from the outsides of the two lateral enclosing plates 13. The handlers 17 are provided for a user to hold or carry. The outer pot body 10 is made of a plastic material, however, not limited to this only.

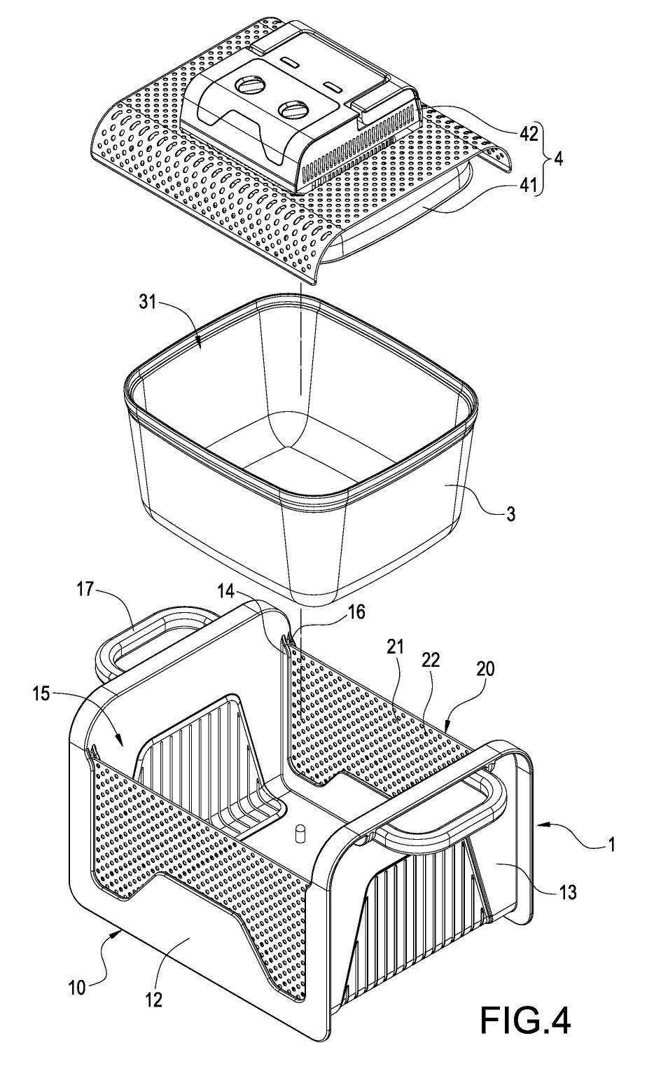

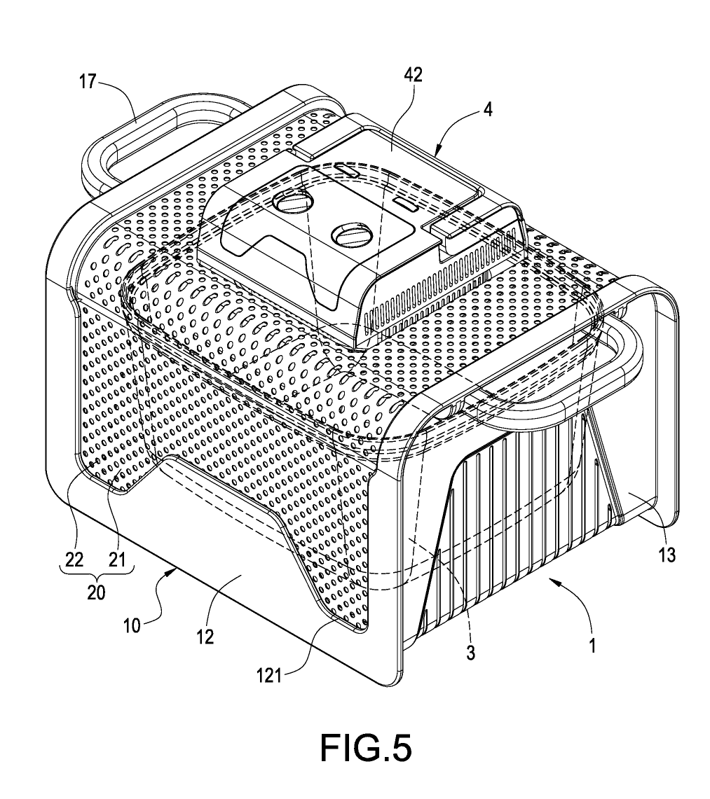

Please refer to FIG. 4 and FIG. 5. The inner pot body 3 fixed in the accommodative space 15 is made of a transparent material and has an accommodative cavity 31. The inner pot body 3 may be made of tempered glass, however, not limited to this only.

The thermally protective structure 20 made of a thermally insulating material is inset into the fixing trough 16 and is arranged corresponding to the opening 121. In the meantime, the thermally protective structure 20 and the outer pot body 10 are co-enclosed around the outside of the inner pot body 3. In this case, the thermally protective structure 20 may be a plate body 21, on which a plurality of cooling holes 22 are provided. The thermally protective structure 20 may be a metallic net, however, not limited to this only.

As shown in FIG. 4, the invention is provided to hold the inner pot body 3 and be covered by a pot lid 4. The pot lid 4 includes a lid body 41 and a heat generator 42 connected to the lid body 41. The heat generator 42 includes a heating element (not shown) arranged in the lid body 41 and a fan (not shown) provided corresponding to the heating element. During assembly, the thermally protective structure 20 is first inserted into the fixing trough 16 and then fixed onto the outer pot body 10. Next, the inner pot body 3 is fixed in the accommodative space 15 of the outer pot body 10. Finally, the lid body 41 of the pot lid 4 covers the inner pot body 3. Thus, the assembly process is complete.

Please refer to FIG. 5. When using the invention, the food to be cooked (not shown) is first placed in the accommodative cavity 31 of the inner pot body 3. Through the heating process of the heating element and the forced convective flow of the fan, the food is heated by a roasting operation. Then, the heat absorbed by the inner pot body 3 passes through the cooling holes 22 and dissipates to the ambience. Furthermore, the user may see through the inner pot body 3 via the cooling holes 22 to observe how the food is being roasted therein.

According to the invention, since a thermally protective structure 20 is affixed to the outer pot body 10, during the using process, it can prevent the user from being scaled because of an accident contact with the inner pot body 3. Therefore, the safety is further secured in terms of use.

### Second Embodiment

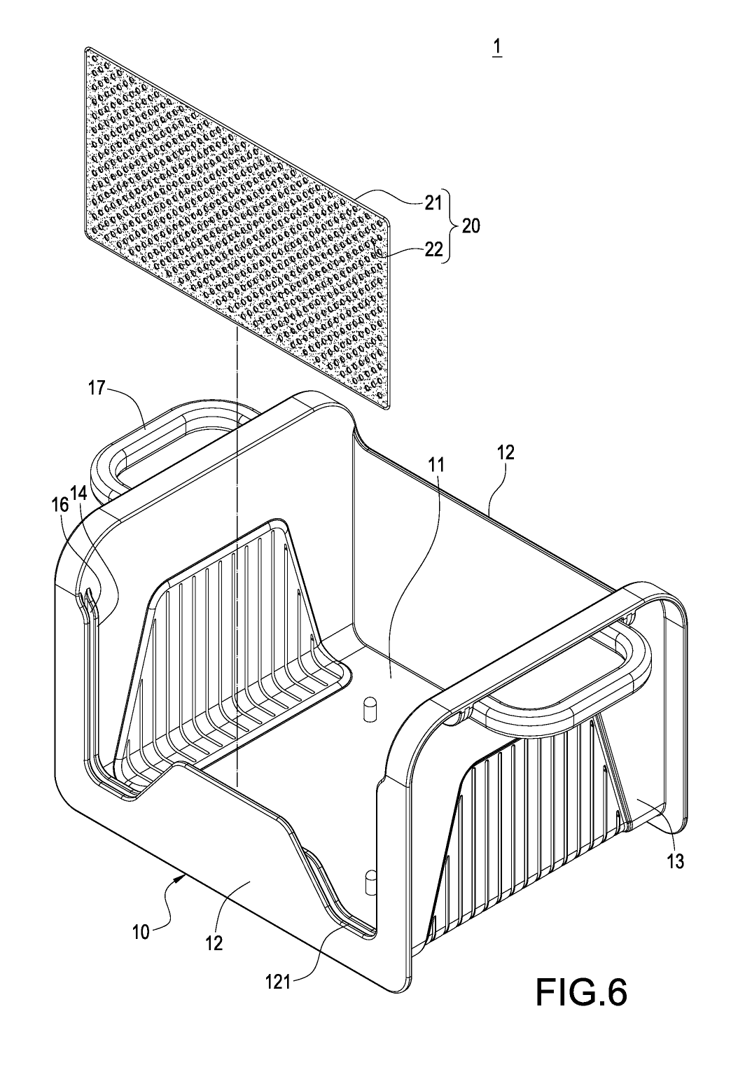

Please refer to FIG. 6. The difference between this embodiment and the previous one is that the thermally protective structure 20 is a metallic net sprayed a thermally insulating paint or implanted with flocking.

### Third Embodiment

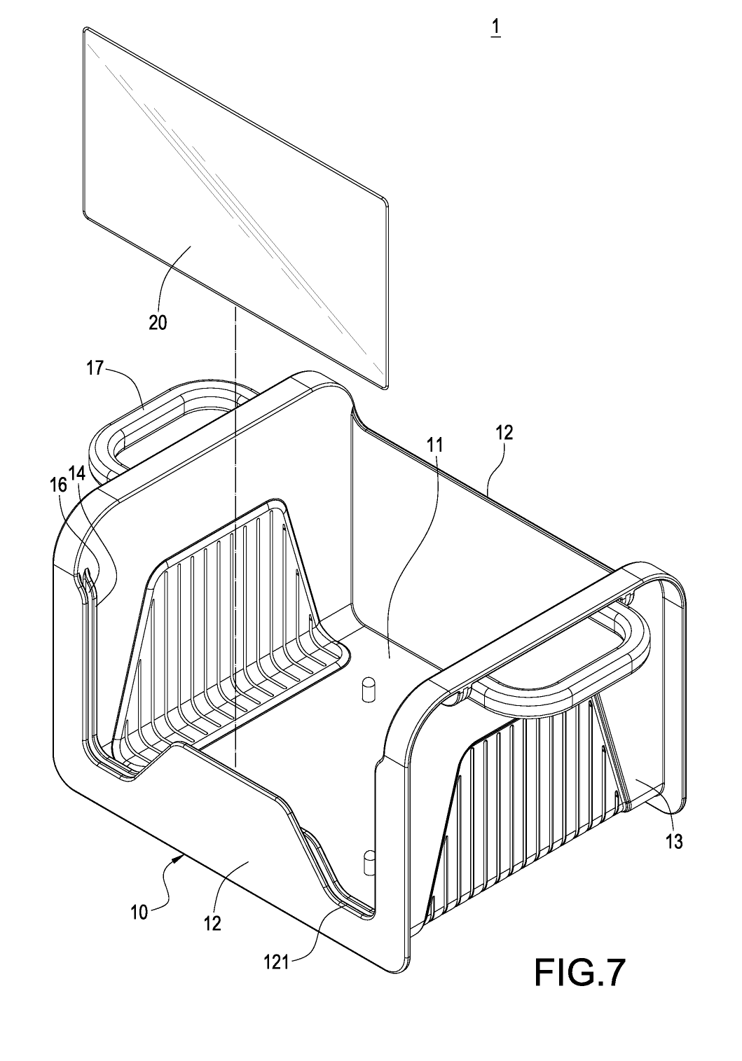

Please refer to FIG. 7. The difference between this embodiment and the previous ones is that the thermally protective structure 20 is a transparent plastic plate or a glass plate.

### Fourth Embodiment

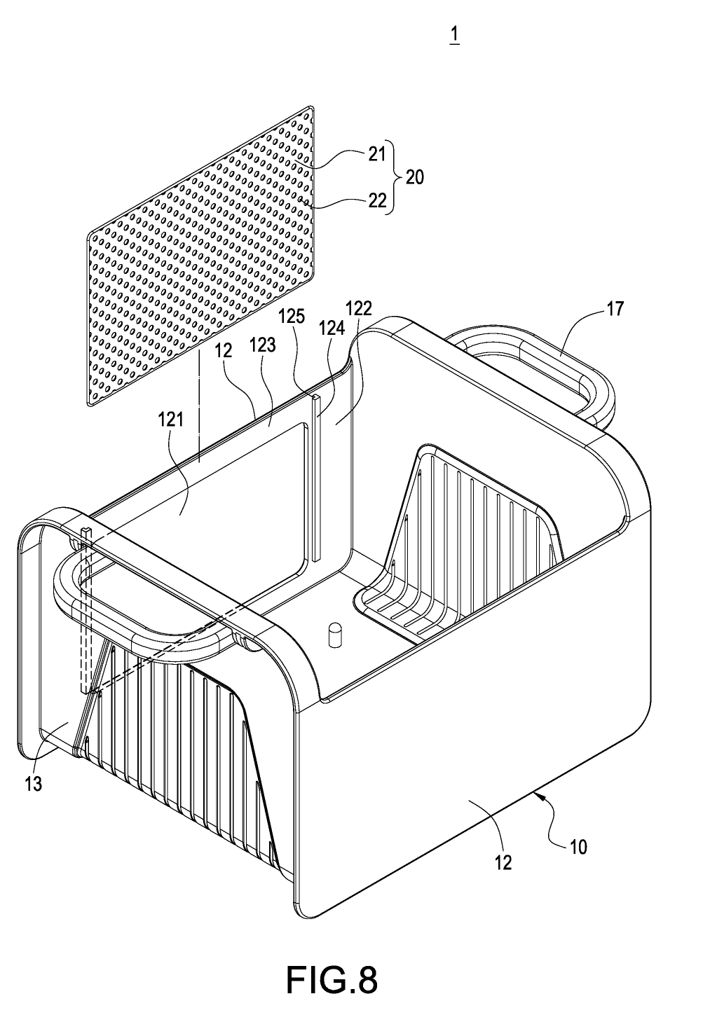

Please refer to FIG. 8. The difference between this embodiment and the previous ones is described as the following. The front enclosing plate 12 is comprised of an enclosing stripe 122 and a cross rod 123 connected the enclosing stripe 122. A buckling stripe 124 is projected from the front enclosing plate 12. A groove 125 formed between the buckling stripe 124 and the front enclosing plate 12 is provided for insetting the thermally protective structure 20 therein. The opening 121 is formed between the enclosing stripe 122 and the cross rod 123, while the thermally protective structure 20 is arranged corresponding to the opening 121.

### Fifth Embodiment

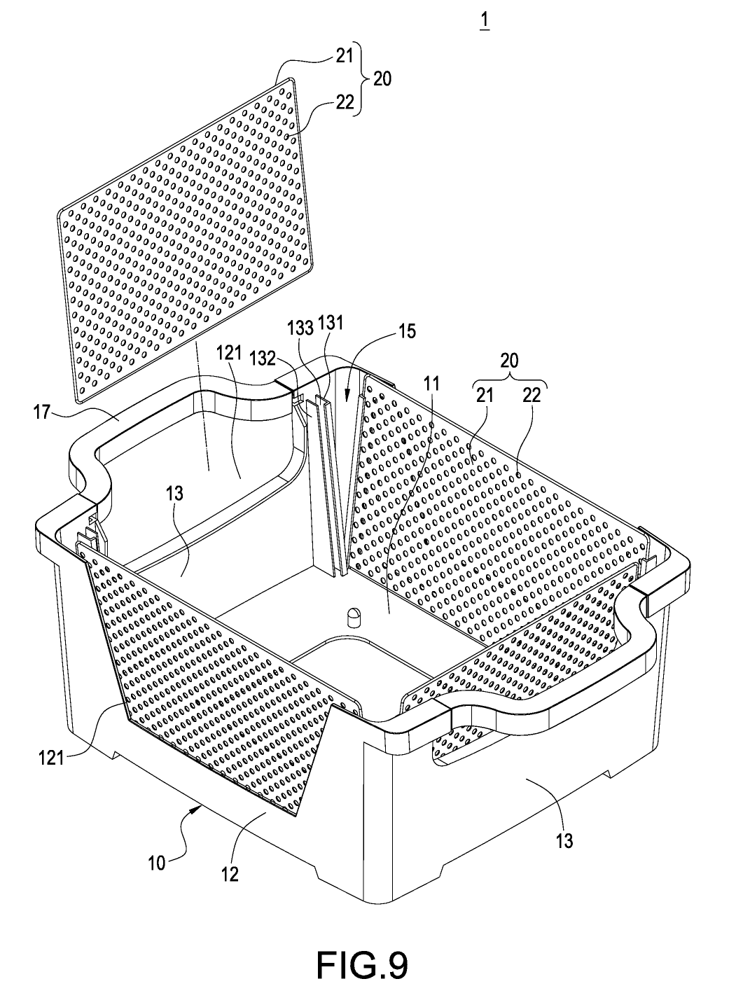

Please refer to FIG. 9. The difference between this embodiment and the previous ones is described as the following. An opening 121 is respectively arranged on the two lateral enclosing plates 13 of the outer pot body 10. A buckling stripe 131 and a projecting stripe 132 are projected from the lateral enclosing plate 13 (or the front, rear enclosing plates 12). In the meantime, an insetting trough 133 formed between the buckling stripe 131 and the projecting stripe 132 is provided for insetting and fixing the thermally protective structure 20 therein, whereby the thermally protective structure 20 is arranged corresponding to the opening 121.

### Sixth Embodiment

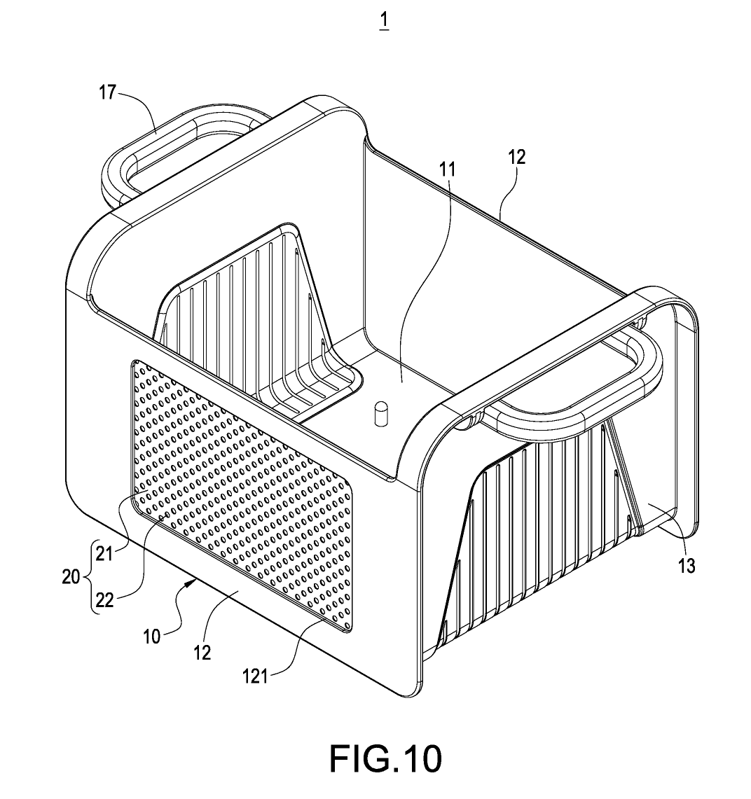

Please refer to FIG. 10. The difference between this embodiment and the previous ones is that the thermally protective structure 20 and the front enclosing plate 12 are formed by an integral enclosure.

### Seventh Embodiment

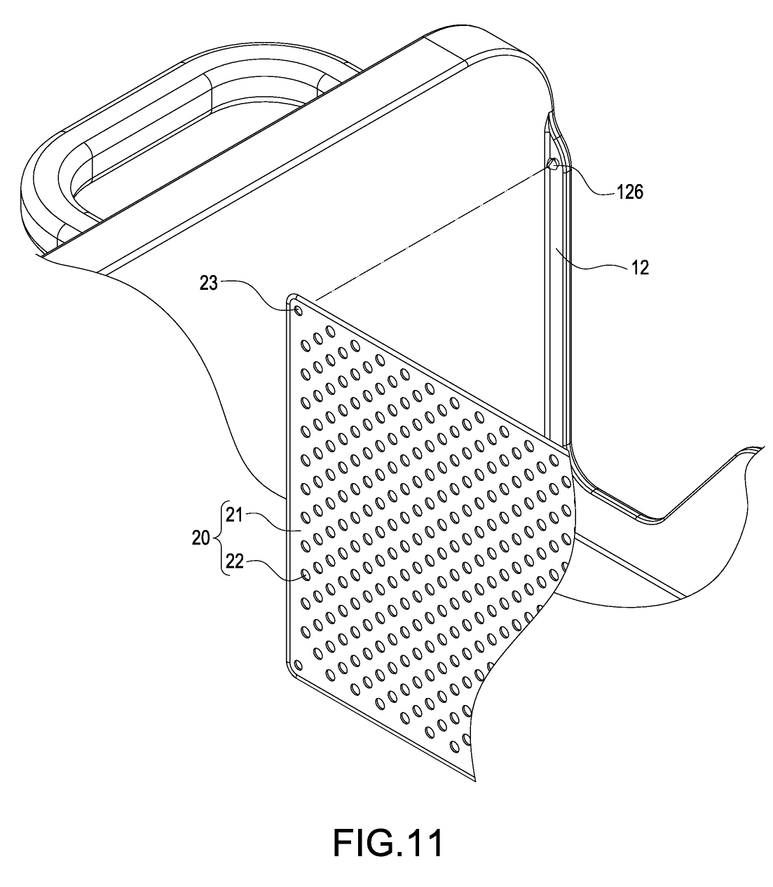

Please refer to FIG. 11. The difference between this embodiment and the previous ones is that the thermally protective structure 20 is arranged a plurality of positioning holes 23 and a plurality of positioning pillars 126 projected from the front enclosing plate 12 (or the rear enclosing plate 12) are provided for separately fitting and fixing the positioning holes 23.

### Eighth Embodiment

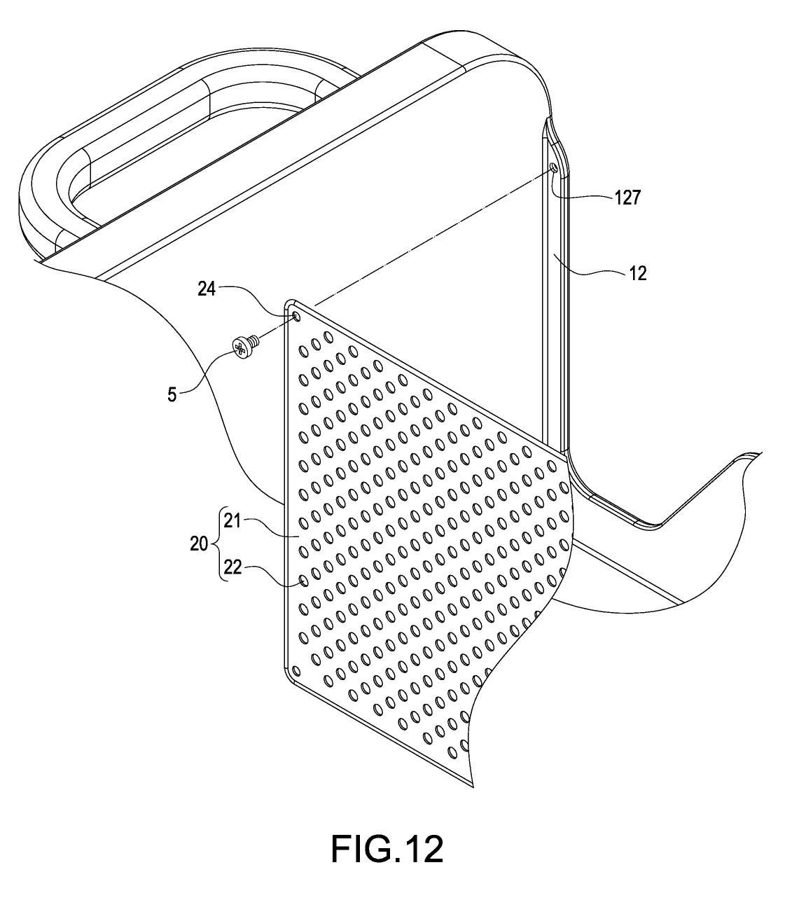

Please refer to FIG. 12. The difference between this embodiment and the previous ones is that at least one threaded hole 127 is arranged on the front enclosing plate 12 (or the rear enclosing plate 12) and the thermally protective structure 20 is arranged a circular hole 24 corresponding to the threaded hole 127, such that the thermally protective structure 20 can be screwed securely via a screw 5.

Summarizing aforementioned description, the holding structure according to the invention is an indispensably novel structure for an inner pot body of roast oven indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A holding device for inner pot body of roast oven, including:
an outer pot body, which has an accommodative space and at least one opening communicated with the accommodative space, while the inner pot body is fixed in the accommodative space; and
a thermally protective structure, which is made of a thermally insulating material, and which is arranged corresponding to the opening, the thermally protective structure and the outer pot body being co-enclosed around an outside of the inner pot body.

2. The holding device for inner pot body of roast oven according to claim 1, wherein the thermally protective structure is a plate body, on which a plurality of cooling holes are provided.

3. The holding device for inner pot body of roast oven according to claim 1, wherein the thermally protective structure is a metallic plate, a metallic plate implanted with a flocking, a metallic plate sprayed with a thermally insulating paint, a plastic plate or a glass-made plate.

4. The holding device for inner pot body of roast oven according to claim 1, wherein a handler is projected from an outside of the outer pot body, and the outer pot body and the thermally protective structure are formed by an integrally injecting enclosure.

5. A holding device for inner pot body of roast oven, including:
an outer pot body, which has a bottom plate and an enclosing plate extended upwardly from the bottom plate, between which an accommodative space is formed, at least one opening being arranged on the enclosing plate, while the inner pot body is fixed in the accommodative space; and
a thermally protective structure, which is made of a thermally insulating material, and which is arranged corresponding to the opening, the thermally protective structure and the outer pot body being co-enclosed around an outside of the inner pot body.

6. The holding device for inner pot body of roast oven according to claim 5, wherein the thermally protective structure is a metallic plate, a metallic plate implanted with a flocking, a metallic plate sprayed with a thermally insulating paint, a plastic plate or a glass-made plate.

7. The holding device for inner pot body of roast oven according to claim 5, wherein the enclosing plate is comprised of an enclosing stripe and a cross rod connected the enclosing stripe, and the opening is formed between the enclosing stripe and the cross rod.

8. The holding device for inner pot body of roast oven according to claim 5, wherein the outer pot body further has a buckling stripe projected from the enclosing plate, and a groove formed between the buckling stripe and the enclosing plate is provided for insetting the thermally protective structure therein.

9. The holding device for inner pot body of roast oven according to claim 5, wherein the outer pot body further has a buckling stripe and a projecting stripe respectively projected from the enclosing plate, and an insetting trough formed between the buckling stripe and the projecting stripe is provided for insetting the thermally protective structure therein.

10. The holding device for inner pot body of roast oven according to claim 5, wherein the thermally projective structure is a plate body, on which a plurality of positioning holes are provided, and a plurality of positioning pillars projected from the enclosing plate are provided for fitting and fixing the plural positioning holes.

11. The holding device for inner pot body of roast oven according to claim 5, wherein a threaded hole is provided on the enclosing plate, while the thermally protective structure has a plate body, on which a circular hole is arranged corresponding to the threaded hole, whereby the plate body is screwed via a screw.

12. The holding device for inner pot body of roast oven according to claim 5, wherein the outer pot body and the thermally protective structure are formed by an integrally injecting enclosure.

13. A holding device for inner pot body of roast oven, including:
an outer pot body, which has a bottom plate, two lateral-enclosing plates extended upwardly from the bottom plate and a front-enclosing plate, among which an accommodative space is formed, in which the inner pot body is fixed, at least one opening being provided on the front-enclosing plate; and
a thermally protective structure, which is made of a thermally insulating material, and which is arranged corresponding to the opening, the thermally protective structure and the outer pot body being co-enclosed around an outside of the inner pot body.

14. The holding device for inner pot body of roast oven according to claim 13, wherein the thermally protective structure is a metallic plate, a metallic plate implanted with a flocking, a metallic plate sprayed with a thermally insulating paint, a plastic plate or a glass-made plate.

15. The holding device for inner pot body of roast oven according to claim 13, wherein the outer pot body further has a side stripe projected from the lateral enclosing plate, and a fixing trough formed between the side stripe and the front enclosing plate is provided for insetting the thermally protective structure therein.

16. The holding device for inner pot body of roast oven according to claim 13, wherein the enclosing plate is comprised of an enclosing stripe and a cross rod connected the enclosing stripe, and the opening is formed between the enclosing stripe and the cross rod.

17. The holding device for inner pot body of roast oven according to claim 13, wherein the outer pot body further has a buckling stripe projected from the enclosing plate, and a groove formed between the buckling stripe and the enclosing plate is provided for insetting the thermally protective structure therein.

18. The holding device for inner pot body of roast oven according to claim 13, wherein the outer pot body further has a buckling stripe and a projecting stripe respectively projected from the enclosing plate, and an insetting trough formed between the buckling stripe and the projecting stripe is provided for insetting the thermally protective structure therein.

19. The holding device for inner pot body of roast oven according to claim 13, wherein the thermally projective structure is a plate body, on which a plurality of positioning holes are provided, and a plurality of positioning pillars projected from the enclosing plate are provided for fitting and fixing the plural positioning holes.

20. The holding device for inner pot body of roast oven according to claim 13, wherein a threaded hole is provided on the enclosing plate, while the thermally protective structure has a plate body, on which a circular hole is arranged corresponding to the threaded hole, whereby the plate body is screwed via a screw.
